(19) United States
(12) Patent Application Publication
(10) Pub. No.: US 2002/0069284 A1
(43) Pub. Date: Jun. 6, 2002

(54) System and method of controlling network connectivity

(76) Inventors: Michael Weston Slemmer, Oakland, CA (US); James William Hannan JR., Palo Alto, CA (US); William Michael Daniher, Redwood City, CA (US); Richard Munro O'Connell, San Francisco, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/859,739

(22) Filed: May 17, 2001

Related U.S. Application Data
(60) Provisional application No. 60/205,015, filed on May 17, 2000.

(51) Int. Cl. G06F 15/16

(52) U.S. Cl. 709/227; 709/217; 709/250

(57) ABSTRACT

Aspects of the present invention include a connectivity application for connecting computer devices to communication networks such as the Internet. The connectivity application, such as, for example, a dialer, communicates with an access provider to ensure the connectivity application is using current connection data. Through the management of the connection data for a large number of connectivity applications, a management server advantageously provides a system administrator the ability to manage capacity, quality and traffic flow through hardware and software systems of an access provider. Moreover, the management server advantageously provides the ability to route around access points experiencing service interruptions, disruptions, or the like.

### REFERENCE TO RELATED APPLICATION

The present application claims priority benefit under 35 U.S.C. §119(e) from U.S. Provisional Application No. 60/205,015, filed May 17, 2000, “SYSTEM AND METHOD OF CONTROLLING A DIALER WHEN ACCESSING A COMMUNICATION NETWORK,” which is incorporated herein by reference.

### BACKGROUND OF THE INVENTION

1. Field of the Invention

Aspects of the present invention are related to systems and methods for connecting computer devices to a communication network. Additionally, aspects of the invention relate to systems and methods of managing capacity, quality, and traffic flow through hardware and software systems available to an access provider.

2. Description of the Related Art

The infrastructure of the Internet, which is known to those of ordinary skill in the art, includes a computer network backbone with computer networks branching from the backbone. These computer networks may comprise individually or in various combinations, private, public, local, wide area, wireless, optical, or satellite networks, or the like, thereby creating an enormous communication system for transferring all manner of information and data from one computing device to others in virtually every country around the world.

As of 1999, sources estimate the Internet having more than 200 million users worldwide and estimate continued exponential growth. Typically, each of the foregoing users employ some type of connection service to connect their computing device to the infrastructure of the Internet. The foregoing connection service generally includes an access point and compatibility bridge. The access point may include, for example, dial-up Internet connections, digital subscriber lines, cable modems, fiber connections, dedicated servers or direct connections, or the like. The compatibility bridge often serves as a protocol translator between the operating systems of the computing device and those of the Internet infrastructure. For example, a compatibility bridge may include software, such as a dialer, for initiating a connection to the Internet and then handling all incoming and outgoing message traffic passed thereto. The organizations, such as, for example, companies, universities, governments, or the like, which often provide the foregoing connection services are generally referred to as Internet Service Providers (ISPs).

In addition to hosting communications between users computing devices and the rest of the Internet, ISPs generally offer other online services, such as email, newsgroup, chat rooms, bulletin boards, electronic document or content hosting, e-commerce functionality, electronic storefronts, distribution tracking, or the like. ISPs typically offer the foregoing Internet access and the other online services for a monthly fee, or in exchange for specific user actions, such as, for example, viewing electronic advertisements while online.

Use of conventional ISP compatibility bridges, such as, for example, dialers, to connect computing devices to various ISP access points creates a number of drawbacks for both the user of the computing device and the ISP. For example, users often have difficulty installing, configuring, or maintaining the foregoing software compatibility bridges on their computing devices. For example, users often are unfamiliar with the ramifications of selecting specific access points, such as, for example, phone numbers, for their dialer. In fact, users may unwittingly select phone numbers that attach to poor or unavailable connections, overused connections, premium cost or tolled connections or connections which otherwise cause consistent difficulty or irritation in establishing communication to the infrastructure of the Internet.

On the other hand, ISPs often do not have sufficient capital to acquire the vast hardware and infrastructure resources that are needed to provide local access points to large numbers of users, often geographically or at least area code remote from one another. Moreover, ISPs may have difficulty ensuring each users maintains current lists of active access points and updated software applications. ISPs may also have difficulty balancing user loads across some or all of their access points.

### SUMMARY OF THE INVENTION

Based on the foregoing, use of conventional ISPs to connect computing devices to the infrastructure of the Internet may cause a number of drawbacks for the users and for the ISPs. Therefore, a need exists in the industry for systems and methods for connecting computer devices to communication networks such as the Internet. Additionally, a need exists for systems and methods of controlling and updating connectivity applications, along with the connection data they rely on, to establish compatibility bridges to access points for the Internet. In addition, a need exists for systems and methods of managing capacity, quality, and traffic flow through the hardware and software systems available to an access provider.

Based on the foregoing, aspects of the present invention include systems and methods for connecting computer devices to communication networks such as the Internet. According to one embodiment, the present invention comprises a connectivity application, resident on a user computing device, which governs communication with the communication network. According to one embodiment, the connectivity application chooses access points to the communication network. Such access points provide connectivity and may include dial-up connections, digital subscriber lines, cable modems, fiber connections, dedicated servers, direct connections, wireless communications links, fixed wireless systems, mobile wireless systems or the like. In another embodiment, a connectivity application chooses the access points based on priorities and percentages assigned to the access points.

In yet another embodiment, a management server adds, deletes or reprioritizes communication service providers or at least some of their associated access points. In still another embodiment, a management server assigns, modifies, and evaluates priorities and percentages assigned to communication service providers or at least some of their associated access points.

In an additional embodiment, the connectivity application communicates with a management server to upload statistical and performance data to the management server. According to yet another embodiment, while the management server communicates with the connectivity application to update connection information associated with the foregoing access points. Through the use of priorities and percentages, the management server advantageously prioritizes, customizes, and evaluates the connection information sent to the user computing devices. Through the foregoing management of priorities and percentages, the management service may advantageously balance system loads, ensure capacity commitments are archived, define user groups or user types, route around problematic access points, and the like. Moreover, according to one embodiment, the management server provides the foregoing functionality with little or no need for user intervention.

These and other advantages and features of the present invention will become more fully apparent from the following description and appended claims taken in conjunction with the accompanying drawings.

### BRIEF DESCRIPTION OF THE DRAWINGS

The present invention is described in more detail below in connection with the attached drawings, which are meant to illustrate and not limit the invention, and in which:

FIG. 1 illustrates a simplified block diagram of a communication system, according to aspects of an embodiment of the invention;

FIG. 2 illustrates a simplified block diagram of the communication system of FIG. 1 wherein a user computing device employs a dialer to access a communication network;

FIG. 3 illustrates a flow chart of a phone book generation process and accompanying exemplary dataflow according to aspects of an embodiment of the invention;

FIG. 4 illustrates a hierarchical relational diagram of metrics that may be used to determine priority values, according to aspects of an embodiment of the invention;

FIGS. 5-9 illustrate exemplary system administrator interface screens associated with the management of phone books, according to aspects of an embodiment of the invention;

FIG. 10 illustrates a flow chart of a connection process, according to aspects of an embodiment of the invention;

FIG. 11 illustrates a flow chart of a server notification process, according to aspects of an embodiment of the invention; and

FIG. 12 illustrates a screen shot associated with a connectivity application, according to aspects of an embodiment of the invention.

### DETAILED DESCRIPTION OF THE PREFERRED EMBODIMENTS

Aspects of the present invention include a connectivity application for connecting computer devices to communication networks such as the Internet. The connectivity application, such as, for example, a dialer, communicates with an access provider to ensure the connectivity application is using current connection data. Through the management of the connection data over a large number of connectivity applications, the access provider may advantageously manage capacity, quality and traffic flow through the access provider's infrastructure. Moreover, a system administrator may use a management server to route around access points experiencing service interruptions, disruptions, or the like, or to tailor the order of connection attempt to take advantage of service agreements, discount pricing, quality, connections or load balancing.

According to one embodiment, the management server employs and manages sets of priorities and percentages assigned to access points or groups of access points. The priorities and percentages are included in connection data transferred, and routinely updated, to the connectivity applications resident on the user computing devices. The connectivity applications use the priorities and percentages in constructing the order of access points the connectivity application will use to establish communication with the communication network.

According to some embodiment, the priorities are generated by evaluating a number of different performance metrics, such as, for example, cost of use, type of user, connection quality, available capacity, or the like. According to another embodiment, some or all of the performance metrics or other statistical data may advantageously be recorded by the connectivity application and uploaded to the management server.

To facilitate a complete understanding of the invention, the remainder of the detailed description describes aspects and embodiments of the invention with reference to the figures, wherein like elements are referenced with like numerals throughout.

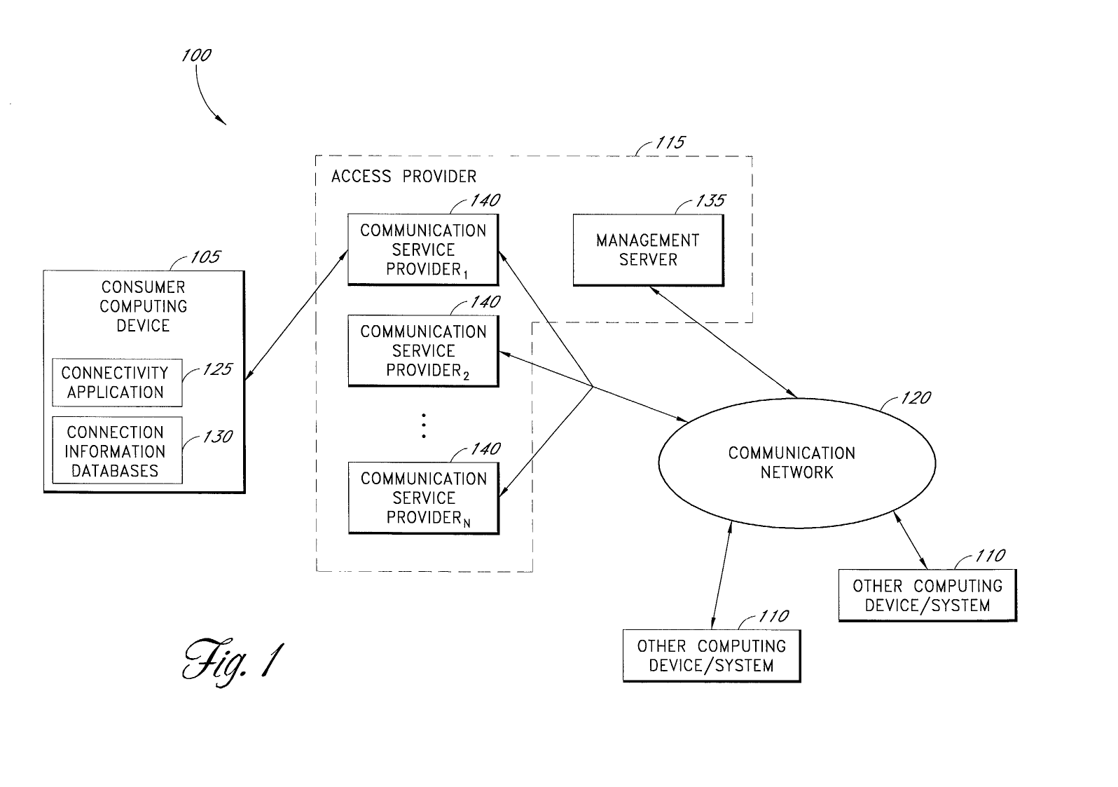

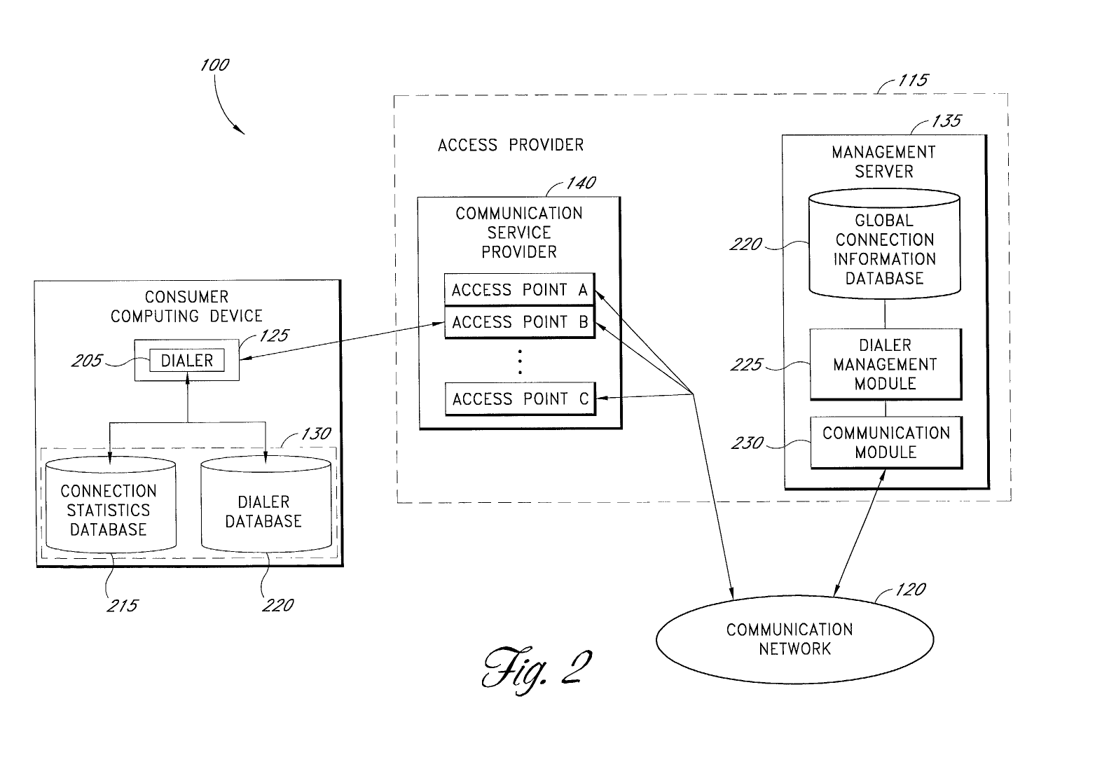

FIG. 1 illustrates a simplified block diagram of a communication system 100, according to aspects of an embodiment of the invention. As is shown in FIG. 1, a user computing device 105 establishes communication with one or more other computing devices or systems 110 through an access provider 115 and a communication network 120. Through the established communication, the user computing device 105 may exchange electronic documents or data, conduct commerce, establish voice or video channels, stream data, listen to music, watch movies, or conduct virtually any manner of activities, familiar to one of ordinary skill in the art, involving communication between computing devices.

According to one embodiment, the user computing device 105 comprises virtually any microprocessor or processor controlled device that permits access to the communication network 120 and may include terminal devices, such as, by way of example, personal computers, workstations, servers, mini-computers, main-frame computers, laptop computers, a network of individual computers, mobile computers, palm top computers, hand held computers, personal digital assistants, cellular or other mobile telephones, a set top box for a TV, an interactive television, an interactive kiosk, smart appliances or other microprocessor included household items, a communication device, an interactive wireless communications device, or any combination thereof. The user computing device 105 may further comprise input devices such as a keyboard, mouse, touch screen, scanner, trackball, microphone, video camera, or the like, and output devices such as a computer screen, television output, speaker, or the like. Furthermore, the user computing device 105 may serve as a client, server, or a combination thereof.

According to additional embodiments, the user computing device 105 may include an addressable storage medium or computer accessible medium, such as random access memory (RAM), an electronically erasable programmable read-only memory (EEPROM), random access memory (RAM), erasable programmable read-only memory (EPROM), hard disks, floppy disks, laser disk players, digital video devices, compact disks, video tapes, audio tapes, magnetic recording tracks, electronic networks, and other devices to transmit or store data.

In one embodiment, the user computing device 105 may advantageously be equipped with a network communication device such a network interface card, a modem, or other network connection device suitable for connecting to the access provider 115. Furthermore, the user computing device 105 may advantageously include an appropriate operating system, such as; for example, Microsoft® Windows® 3.1, Microsoft® Windows® 98, Microsoft®, Windows® 98 Second Edition®, Microsoft® Windows® Millennium Edition®, Microsoft® Windows® NT, Microsoft® Windows® 2000, Microsoft® Windows® CE, PalmOS®, Apple® MacOS®, Linux®, Solaris®, IRIX®, UNIX®, IBM® OS/2® operating system, or the like.

Additionally, according to one embodiment, the operating systems may advantageously include a TCP/IP stack or other network communications protocol which handles incoming and outgoing information or data. In other embodiments, the operating system and communication protocols may differ or be differently configured depending on the type of hardware and software systems accompanying the user computing device 105, however, the operating system may advantageously continue to provide the appropriate network communications protocols necessary to establish communication links with the access provider 115.

FIG. 1 also shows the communication system 100 including the communication network 120. According to one embodiment, the communication network 120 advantageously comprises the Internet. The Internet, as used herein, comprises a global network of interconnected computer systems capable of sending and receiving information and data. As disclosed in the foregoing, the structure of the Internet includes a network backbone comprising communications channels such as copper wire or optical fiber based interconnections between numerous computers, hubs, and routers. The network backbone, and component devices therein, control, direct, and maintain information passed between computers. Additional networks branch from the above-mentioned backbone with these branches, in turn, have sub-networks branching from them, and so on.

Typically, information or data is passed through the Internet in the form of discrete pieces the information, or packets. Packets may comprise information encoded in a form interpretable by the network infrastructure and may support features such as data compression, encryption authentication, and error correction to optimize the speed security and efficiency by which the information is transferred. For a more detailed description of the structure and operation of the Internet, please refer to “The Internet Complete Reference,” by Harley Hahn and Rick Stout, published by McGraw-Hill, 1994.

One of ordinary skill in the art will recognize that the communication network 120 may be advantageously comprised of other types of networks without detracting from the invention. For example, the communication network 120 may include peer-to-peer networks, bulletin board services (BBSs), local area networks (LANs), wide area networks (WANs), public or private internets or intranets, a private computer network, a private network, a public network, a value-added network, interactive television networks, wireless data transmission networks, two-way cable networks, interactive kiosk networks, and the like. Thus, the communication network 120 is suitable for providing connectivity through many different forms of communications mediums, however, to facilitate a complete understanding of many of the aspects of the invention, the remainder of the detailed description use the communication network 120 in the context of the Internet.

FIG. 1 also shows the communication system 100 including the access provider 115. According to one embodiment, the access provider 115 comprises hardware and software systems for providing computing devices access points to the communication network 120. For example, one or more access providers 115 may have access points that advantageously include dial-up connections, digital subscriber lines, cable modems, fiber connections, dedicated servers, direct connections, wireless communications links, fixed wireless systems, mobile wireless systems or the like.

According to one embodiment, the user computing device 105 advantageously communicates with the communication network 120 through one or more of the foregoing access points of the access provider 115.

FIG. 1 also shows the other computing devices 110. According to one embodiment, the other computing devices 110 each comprise any combination of those devices disclosed with reference to the user computing device 105. For example, the other computing devices 110 may include World Wide Web servers which serve electronic documents, data, music, multimedia, or the like to the user computing device 105.

Based on the foregoing, the communication system 100 provides a system whereby a user computing device 105 can advantageously establish communication to a wide variety of different types of other computing devices 110 through the access provider 115 and the communication network 120.

In addition to the foregoing, FIG. 1 also shows the user computing device 105 comprising a connectivity application 125 and one or more connection information databases 130. According to an embodiment, the connectivity application 125 advantageously includes software applications, such as drivers for hardware or the like, and user interfaces for configuring the same. For example, the connectivity application 125 may advantageously access the hardware resident on the user computing device 105 such that the hardware creates a connection to one or more access points of the access provider 115. According to one embodiment, the connectivity application 125 may comprise a dialer, an interface for Asychronous Transfer Mode (ATM), a Point to Point protocol (PPP) over ethernet connector, different network connectivity software, software to connect over fixed or mobile wireless systems or the like.

Although the connectivity application 125 may advantageously include many different software applications, to facilitate a complete understanding of many of the aspects of the invention, the remainder of the detailed description describes the connectivity application in the context of a dialer and the connection information in the context of phone numbers for the dialer to dial and other connection information to configure the dialer.

According to one embodiment, the connection information databases 130 comprise connection information relating to the access points of the access provider 115. The information databases 130 may advantageously comprise tables, data or database files, text files, or the like, stored in computer accessible or addressable storage media. According to one embodiment, the connection information may advantageously include contact information, such as phone numbers, for contacting various access points provided by the access provider 115. In addition, the contact information may include associated protocols suitable for configuring particular types of connectivity applications for particular access points.

According to one embodiment, the connection information includes priorities and percentages associated with individual or groups of access points of the access provider 115. The priorities and percentages may advantageously be based on a wide number of different performance metrics or quality statistics relating to prior or current use of, for example, one or more of the access points, user configurations, desired network loads, preferred pricing, or the like. The priorities and percentages associated with the connection information will be disclosed in further detail below.

FIG. 1 shows the access provider 115 comprising a management server 135 and one or more communication service providers (CSPs) 140. According to one embodiment, the management server 135 comprises one or more server systems. For example, the server systems may include network connectivity comprising high-volume and high-speed direct connections to the communication network 120. The server systems may also include backend 100 Mps switches for one or more database servers, such as, for example, those servers compatible with database management systems commercially available from, for example, Oracle Corporation. As is known to a skilled artisan, the server systems may have redundancies such as full or partial mirrors, fault protection, anti-virus, or other security and fail safe systems installed therein.

Although the management server 135 is disclosed with reference to its preferred and alternative embodiments, the invention is not intended to be limited thereby. Rather, a skilled artisan will recognize from the disclosure herein a wide number of alternative software and hardware configurations for the management server 135, such as, for example, those configurations for varying communication networks or user computing devices.

According to yet another embodiment, the management server 135 includes software systems designed to provide a large amount of flexibility in creating, organizing, prioritizing, and otherwise updating and managing connection data for particular users or groups of the users. For example, through the assignment and updating of the connection data, the management server 135 advantageously governs and customizes the connection order used by the connectivity application 125 of the user computing device 105. As the management server 135 creates the connection orders for multiple connectivity applications, the management server 135 is able to direct the capacity, quality and traffic flow through the access provider 115.

FIG. 1 shows the access provider 115 including the one or more CSPs 140. According to one embodiment, the one or more CSPs 140 comprise the hardware and software systems for establishing communication between the user computing device 105 and the communication network 120. For example, the CSPs 140 may include the foregoing ISPs known to the skilled artisan, such as, for example, dial-up Internet connections, digital subscriber lines, cable modems, fiber connections, dedicated servers, or the like.

According to one embodiment, each of the one or more CSPs 140 may a part of the business entity of the access provider 115, when that business entity includes sufficient resources to provide access points for, for example, large numbers of potentially geographically and area code diverse users. Alternatively, the business entity of the access provider 115 may form a wide number of relationships with various independent CSPs in order to offer access to users who are accessing from places not within the business entity's network. For example, a national access provider 115 may contract with independent CSPs 140 to offer access to areas within a state, entire states, groups of states, or the like, where the national access provider needs additional infrastructure to provide users with quality local access points to the communication network 120. The need may derive from the national access provider not having needed infrastructure, not having sufficient infrastructure, not having sufficient infrastructure during peak use, finding less expensive or higher quality infrastructure, or the like, in the foregoing areas. In such instances, the access provider 115 employs the management server 135 to provide the connectivity applications 125 of the disperse user computing devices 105 with prioritized connection data from virtually any combination of access points offered by virtually any combination of the available contracting CSPs 140. According to one embodiment, the management server 135 may advantageously prioritize the connection data to configure a wide number of desired attributes for the hardware and software systems contracted with the access provider 115, such as, for example, to direct the capacity, quality and traffic flow therein.

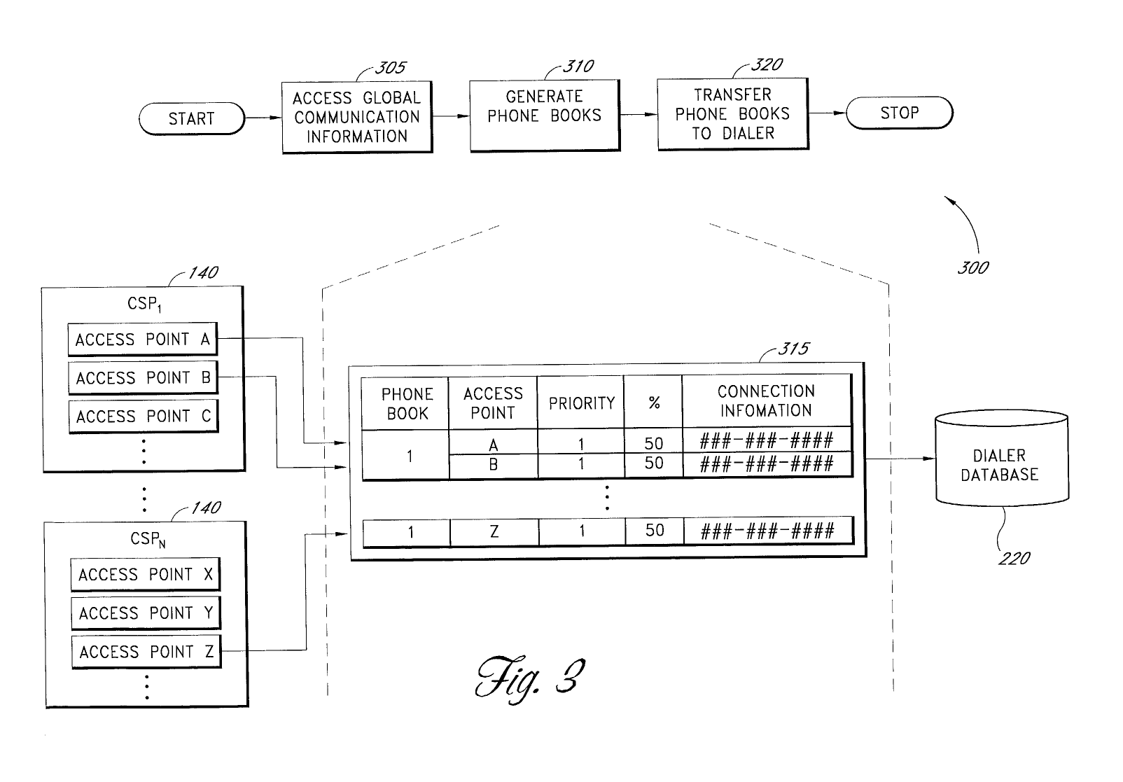

FIG. 2 illustrates a simplified block diagram of the communication system 100 of FIG. 1, wherein the connectivity application 125 comprises a dialer 205 configured to instruct a modem to access one of a number of access points provided by independent CSP 140. As shown in FIG. 2, the dialer 205 accesses a dialer database 210 to determine which connection information will be used to configure the modem of the user computing device 105, thereby establishing communication with the communication network 120 through the CSP 140. As described in the foregoing, the connection information may advantageously include priorities and percentages for allowing the dialer 205 to choose the connection information by increasing or decreasing preference. FIG. 2 also shows the dialer 205 accessing a connection statistics database in order to store information related to performance metrics or connection statistics associated with access points within the CSP 140, groups of access points, the CSP itself, or the like.

FIG. 2 also illustrates the CSP 140 including a number of access points, such as, for example, modems of, for example, a modem bank, for establishing communication with the dialer 205. According to embodiment illustrated, the dialer 205 may advantageously select the connection information from the dialer database 210 associated with Access Point B, configure the modem to the proper protocols, handshaking, and securities, and dial the phone number associated with Access Point B, thereby establishing communication with the communication network 120.

FIG. 2 also shows the management server 135 comprising a global connection information database 220, a dialer management module 225 and a communication module 230. According to one embodiment, the database 220 stores information related to each of the access points for each of the CSPs 140 associated with or related to the access provider 115 through ownership or other agreements. The information may advantageously include global priorities and percentages, geographic locations, connection information, performance metrics, statistics, network load information, or the like.

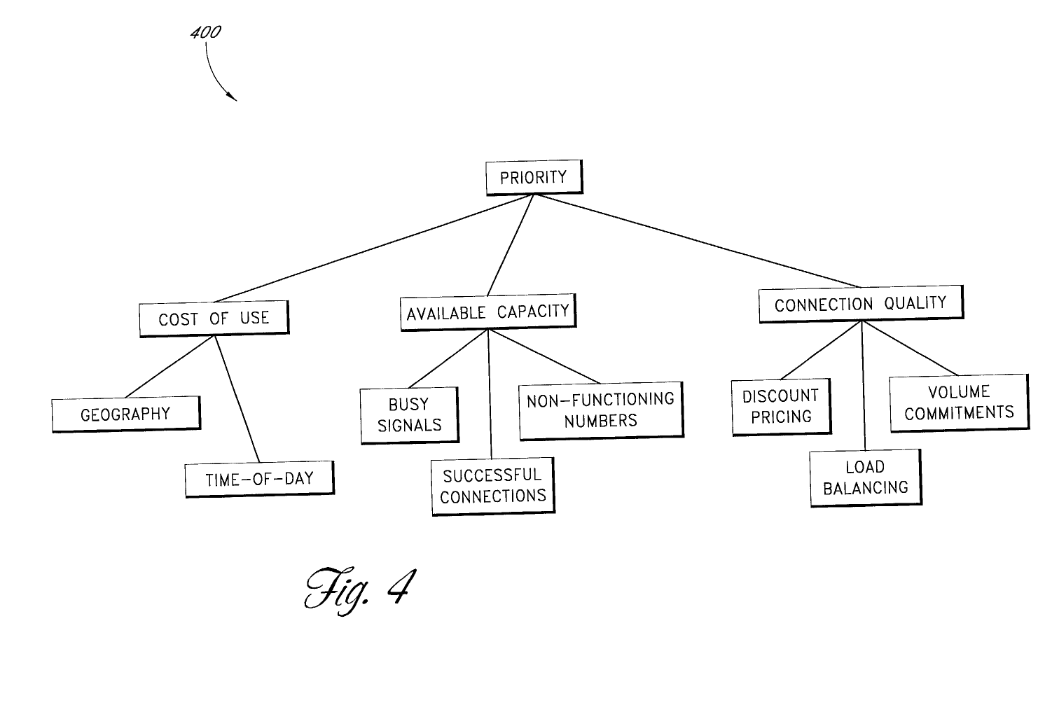

According to another embodiment, the dialer management module 225 uses the information of the information database 220 to customize connection information to be sent to the dialer 205. As disclosed in the foregoing, the management module 225 advantageously generates groups of connection information, called phone books, associated with some or all of the access points from the CSP 140 to customize and manage the systems of the access provider 115 and ensure quality connection for the user. Because of the highly configurable nature of the phone books, the permutations and level of granularity are very broad and are disclosed in further detail below with reference to FIG. 3.

FIG. 2 also illustrates the management server 135 including a communication module 230. According to one embodiment, when the management module 225 generates or updates the phone books for a particular user, the management module 225 transfers the phone books to the communication module 230, which in turn handles the transfer of the phone books to, for example, the dialer database 210 of the user computing device 105.

FIG. 3 illustrates a flow chart of a phone book generation process 300 and accompanying exemplary dataflow diagram, according to aspects of an embodiment of the invention. As shown in FIG. 3, the generation process 300 begins with BLOCK 305 where the dialer management module 225 access the global connection information stored in the information database 220 of the management server 135. As shown in FIG. 3, the global connection information may advantageously include many CSPs 140, each having many access points providing communication links to the communication network 120. At BLOCK 310, the management module 225 uses the global connection information to generate one or more phone books for a particular user, groups of users, or all users. The user groups may advantageously be defined by subscription type, geography, or the like, and as disclosed in the foregoing, the highly configurable nature of the phone books provides permutations and levels of granularity that are very broad. For example, an embodiment of straightforward phone books may advantageously assign each available access point for a particular CSP 140, along with other connection information, and a priority and percentage to a particular phone book. For example, when the access provider 115 included three wholesale CSPs 140, such as, for example, UUNet, Splitrock, and Genuity, Customer A may receive three phone books with the available numbers from the three CSPs 140. According to one embodiment, the management module 225 may also assign priorities to each phone book, access points within each phone book, or any combination thereof, for a large number of different rationale. For example, the management module 225 may be configured to emphasize the cost of use, the quality of connections, the available capacity, or combinations thereof, for each CSP 140, for each access point, or for combinations of the foregoing. For example, according to the example, the management module 225 may assign a high priority to UUNet, a middle priority to Splitrock, and a lower priority to Genuity. According to one embodiment, when the phone books are downloaded to the user computing device 105, the dialer 205 will first dial UUNet numbers, and if unsuccessful, will then dial Splitrock numbers and so on.

According to an embodiment of more complicated phone books, the management module 225 may advantageously recognize two classes of customers, for example, regular subscriber Customer A, and premium subscriber Customer B. According to this embodiment, the management module 225 may assign phone books from the foregoing three wholesale CSPs 140, giving Customer B a high priority on the highest quality CSP, in our example, UUNet, and lower priorities on lowers quality CSPs 140. The management module 225 may then assign, for example, the reverse priorities to Customer A, thereby ensuring load balancing across the network.

Alternatively, the management module 225 may leave out certain access points based from certain phone books based on user type, geography, subscription, or the like. In such case, the corresponding dialers 205 receiving the phone books will not have access to the left-out access points. According to one embodiment, a system administrator may manually manipulate the phone books to, for example, route users around CSP access points which are no longer valid, are below minimum quality thresholds, experiencing an interruption in service, or the like.

Similar to priorities, the management module 225 may employ percentages to one or more phone books or one or more access points within a phone book. For example, the management module 225 may advantageously assign percentages governing the probability that the dialer 205 will access, for example, two phone books or access points having the same priority. Thus, according to one embodiment, when the management server assigns a phone book a percentage of 50 (phone book one), and assigns phone book two the same priority and a percentage of 50. The dialer 205 will dial access points from phone book one 50 percent of the time it dials access points from phone books one and two.

Although the management module 225 is disclosed with reference to its preferred and alternative embodiment, the invention is not intended to be limited thereby. Rather, a skilled artisan will recognize from the disclosure herein a wide number of alternatives for setting priorities and percentages. For example, the priorities may be automatically generated based on, for example, a formula for evaluating one or more performance metrics or quality statistics uploaded from the user computing device 105, multiple user computing devices, or the like. Also, the priorities and percentages may be assigned to individual access points, groups of access points, phone books, groups of phone books, or the like. Additionally, priorities and percentages may be assigned based on time of day, geography, hardware or software configurations of various portions of the communication system 100, or the like.

Furthermore, the priorities can define whether a CSP 140 or the access point of a CSP 140 expires after a period of time. For example, if a contract with a particular CSP 140 for services at a particular price terminates after a predetermined period of time, the priorities can reflect the date or time of termination. Alternatively, the priorities can be updated near the time of termination. Thus, when the management module 225 generates the foregoing highly customizable phone books, the access provider 115 may advantageously and easily manage capacity, quality and traffic flow through various CSP systems associated with the access provider 115.

FIG. 3 shows an exemplary phone book 315 having exemplary connection information, access points, priorities, and percentages, drawn from the global information for some of the access points available to the CSPs 140.

According to one embodiment, after the phone books are generated, the generation process 300 continues to BLOCK 320 where the phone book data is transferred to the dialer 205. Thus, based on the foregoing, the management module 225 advantageously employs the generation process 300 to generate highly customizable phone books for each dialer 205, groups of dialers, or the like.

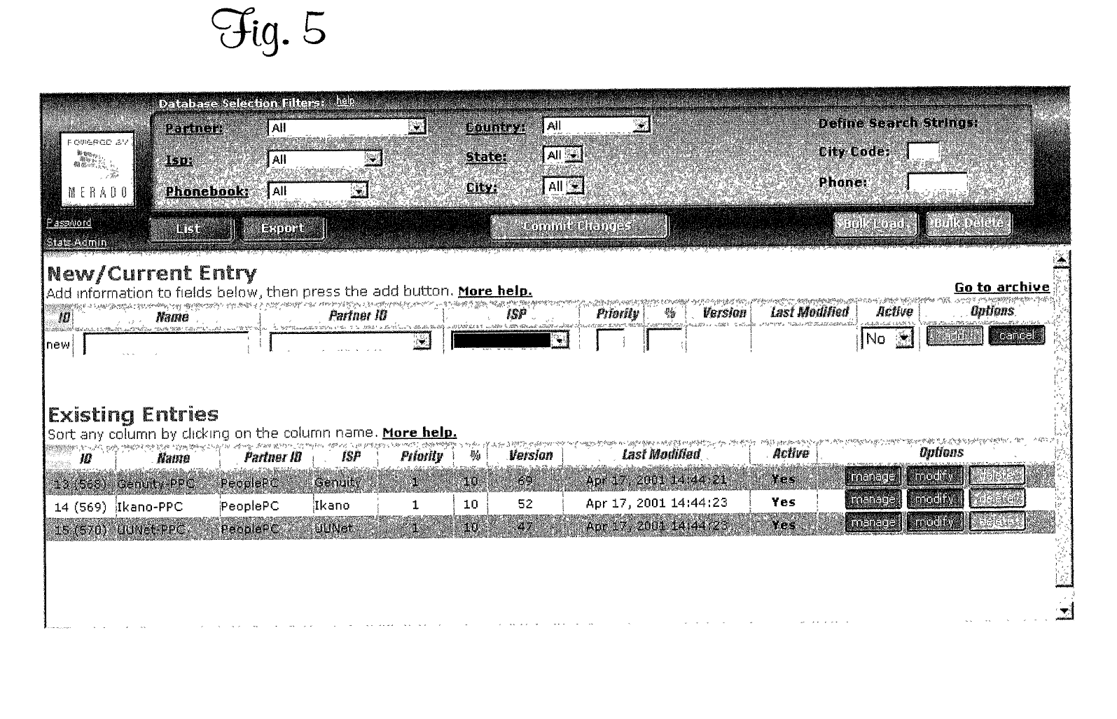

FIG. 4 illustrates a hierarchical relational diagram 400 according to aspects of another embodiment of the invention. As shown in FIG. 4, the value of a priority for a particular access point, whether numeric, alphabetic, or any combination thereof, may advantageously comprise one or more performance metrics or quality statistics. For example, one exemplary metric or statistic comprises a cost of use for a particular access point. For example, each access point, maintained or hosted by the access provider 115 for its users, may have a cost of use associated therewith. According to one embodiment, the cost of use may be related to a leased aspect of use through agreements with the CSP 140, may reflect the hardware or maintenance cost when the access point is maintained directly by the access provider 115, or a combinations thereof. According to additional embodiments, the cost of use may be subdivided by the time of day, geography, or the like.

FIG. 4 also illustrates the exemplary metrics including connection quality. According to one embodiment, the connection quality comprises a measurement of the quality of a connection with which the connectivity application 125 encounters while connected to a particular access point. In one aspect, statistics acquired by the connectivity application 125 while online are employed in determining the connection quality, such as, for example, connection speed, time of connection, interrupts, dropped or cancelled connections, busy signals, successful connections, nonfunctioning numbers, or the like. Additionally, the metrics or statistics may include an assessment of the available connection capacity of a particular access point. According to one embodiment, available capacity may include assessments of discount pricing arrangements, volume commitments made by the access provider 115 to one or more of the CSPs 140, load balancing issues, bandwidth, idle time, or the like.

Thus, the management module 225 reviews the foregoing metrics and statistics when setting the value of the priority. The priorities may also be manipulated to route around poor or interrupted service connections, efficiently utilization available access points or CSPs 140, monitor and customize connection loads, improve overall efficiency of day to day operations, increase the scalability of the access provider 115, or the like.

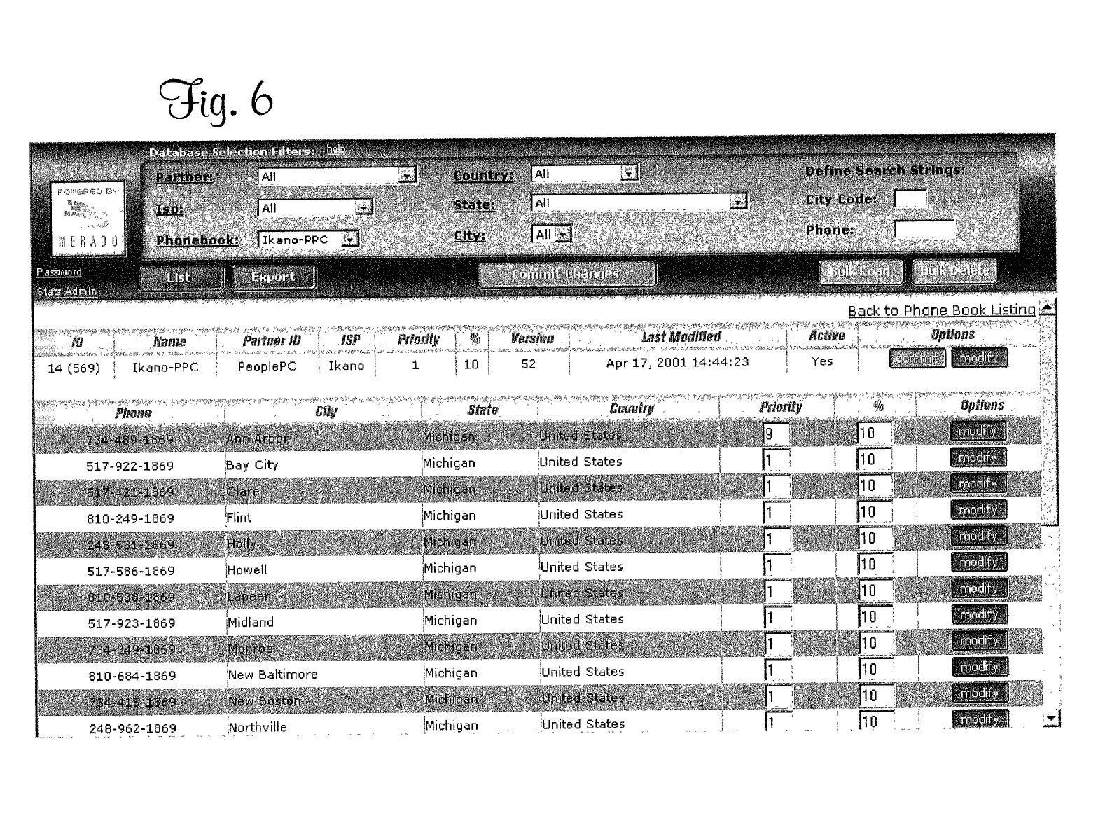

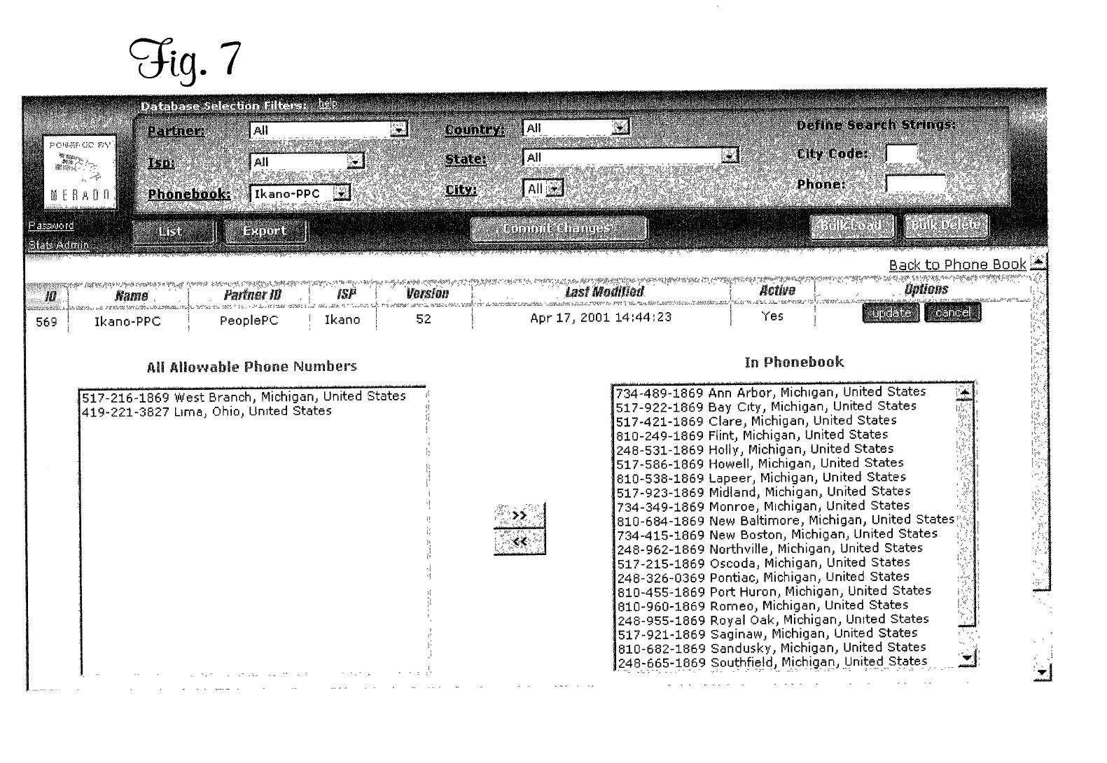

FIGS. 5-9 illustrate exemplary system administrator interface screens according to aspects of an embodiment of the invention. In particular, FIG. 5 illustrates an exemplary interface for viewing, developing, entering, or creating phone books for one or more of the user computing devices 105. As shown in FIG. 5, the interface provides the system administrator the ability to add or delete entire phone books, or to manage particular phone books. According to one embodiment, selecting to manage one or more of the phone books brings the system administrator to the interface shown in FIG. 6. As shown in FIG. 6, the interface of this exemplary embodiment provides the system administrator the ability manually set, override, or update default priorities and percentages for each access point in the phone book. According to one embodiment, the management module 225 may advantageously generate the default priorities from, for example, the metrics and statistics received from the connectivity application 125, groups of connectivity applications, or the like. Such metrics and statistics may advantageously include those disclosed with reference to FIG. 4, or the like.

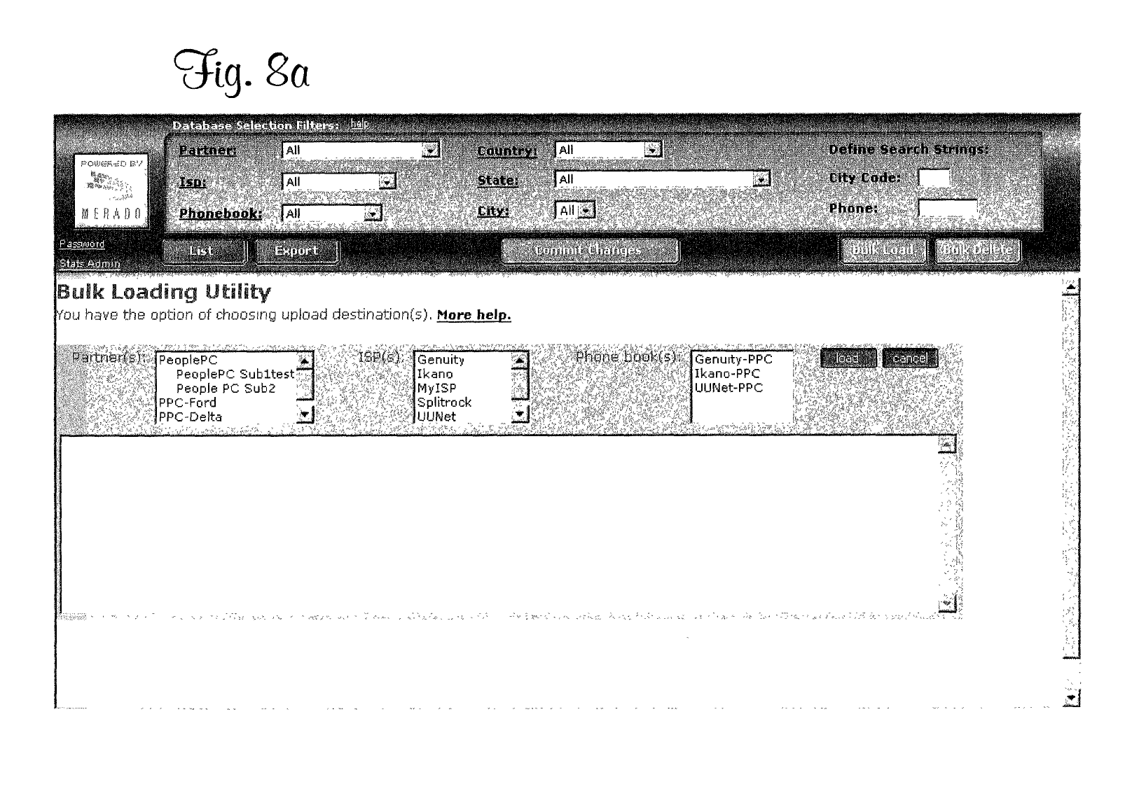

According to one embodiment, choosing to modify connection information for a particular access point within a phone book brings the system administrator to the interface shown in FIG. 7. As shown in FIG. 7, the interface of this exemplary embodiment provides the system administrator the ability manually include or exclude each phone number and associated connection information for a particular or groups of CSPs 140.

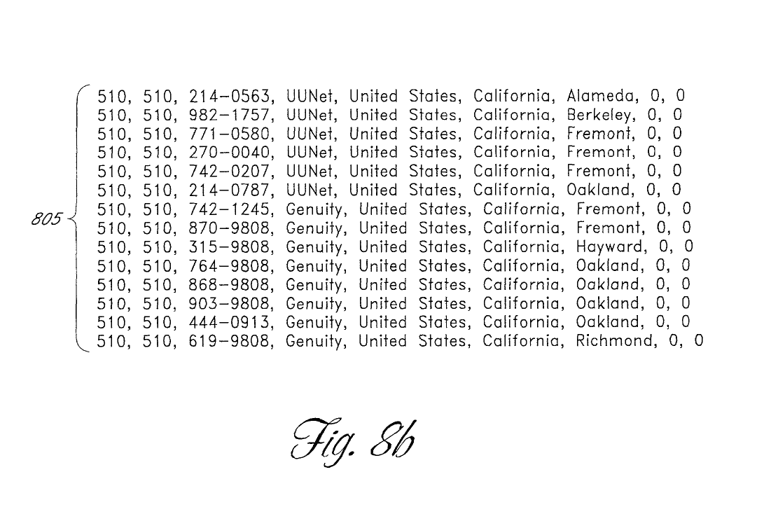

FIG. 8 illustrates an interface for facilitating the bulk loading of connection information for large groupings of access points, CSPs, or the like. As shown in FIG. 8, the system administrator may advantageously receive bulk updated connection information 805 from one or more of the CSPs. According to one embodiment, the system administrator may choose to bulk import or load the updated or new data, rather than individually entering the connection information for each access point.

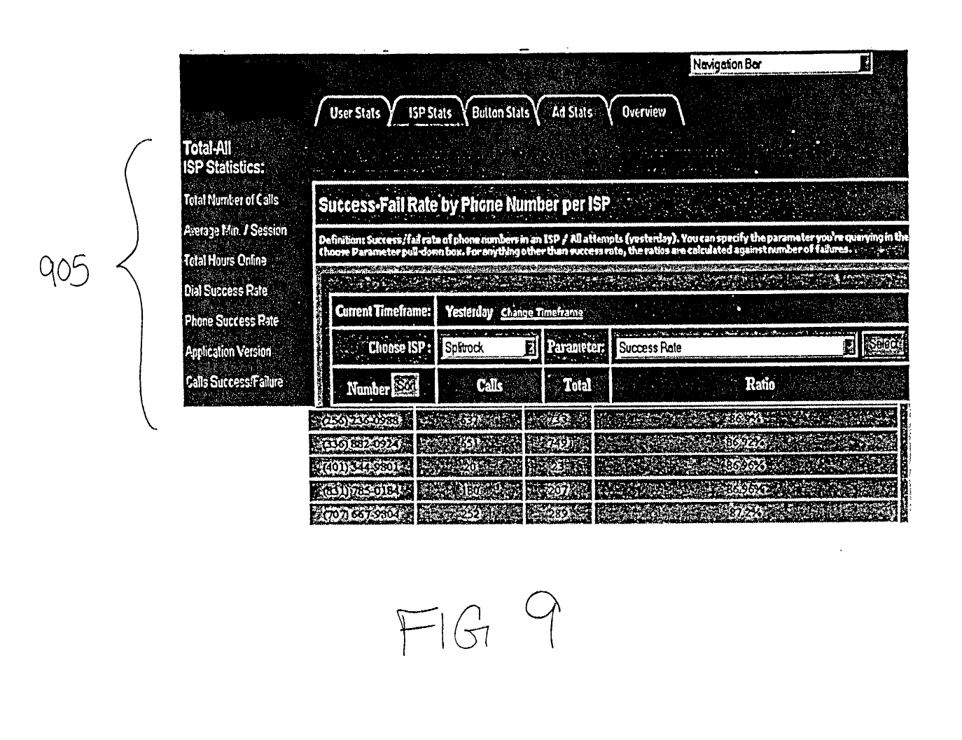

FIG. 9 illustrates an exemplary interface screen providing the system administrator the ability to review and analyze statistics uploaded from one or more connectivity applications 125. According to one embodiment, the interface includes informational categories 905 organizing the performance statistics into information relating to, for example; total number of calls, average time per session, total time online, dial (connection) success rate, phone success rate, connection speed, application version, and success-failure rates. In the illustrated embodiment, the interface illustrates a review of the success rate by phone number per CSP 140. This embodiment of the interface also includes query fields for selecting between CSPs and other parameters design to allow the system administrator to efficiently and effectively sort and view the collected statistical data. Once selected, the statistics for each access point maintained by the CSP are displayed along with the desired statistical information.

Based on the foregoing, the interfaces of FIGS. 5-9 display and organize information for the system administrator, thereby permitting rapid identification of potential problems with the CSPs 140 or rapid modification of attributes for each phone book. It will be appreciated by those of skill in the art that additional interfaces having additional functionality may provide other methods of sorting statistical information relating to the CSPs 140, users, incoming connections, and priority values, or the like, and may provide other methods by which the access provider 115 can monitor important characteristics of user connectivity and CSP performance.

In another embodiment, the process occurs without continued input from the system administrator. For example, the management module 225 has software that automatically updates and evaluates a number of different performance metrics, such as, for example, cost of use, type of user, connection quality, available capacity, termination date, percentage of use, or the like. The management module 225 then alters the selection, addition, deletion or prioritization of CSPs 140 or a portion of their associated access points. Indeed, a wide variety of priorities can also be combined based on desired preferences. In one such embodiment, the management module 225 uses defined thresholds to determine the selection, addition, deletion or prioritization of CSPs 140 or a portion of their associated access points. For example, if an entity favors cost over quality, the cost and quality thresholds could be set to favor quality. Alternatively, if an entity favors available capacity over cost, the capacity and cost thresholds could be set to favor capacity. In yet another embodiment, the management module 225 self adjusts the thresholds or other prioritization parameters based on the obtained statistical data.

Thus, the foregoing interfaces advantageously present information such that the system can efficiently and effectively manage large numbers of access points for large numbers of CSPs associated with the access provider 115. In addition, the interfaces provide efficient display of information related to the services that users of the access provider 115 are receiving, thereby facilitating effective solutions.

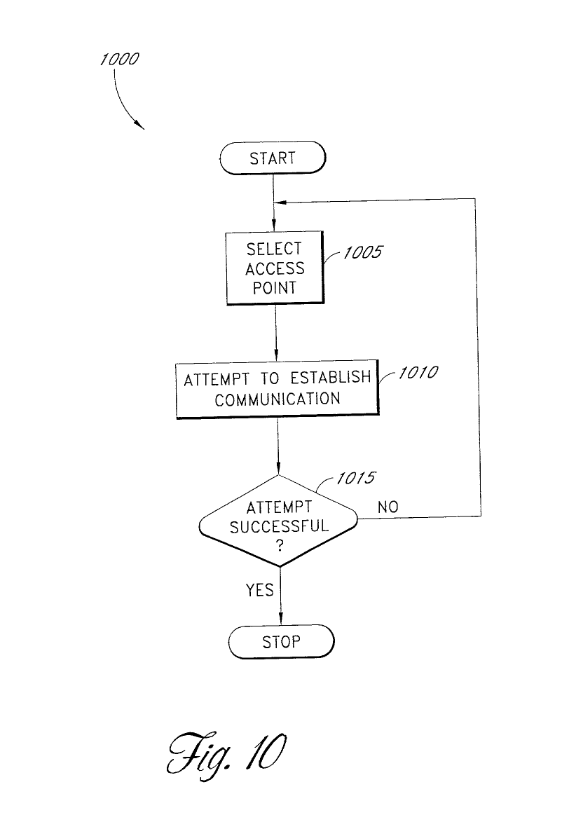

FIG. 10 illustrates a flow chart of a dialer connection process 1000, according to aspects of the invention. As shown in FIG. 10, the connection process 1000 begins with BLOCK 1005 where the dialer 205 selects an access point from the phone books stored in the dialer database 220. In one aspect, the dialer 205 automatically selects an appropriate access point based on, for example, access points created or downloaded during a last connection, created during a user account setup, or created or downloaded at anytime prior to the current connection attempt.

As disclosed in the foregoing, each phone book, and in some embodiments, each access point, may comprise a priority and a percentage. According to one embodiment, the dialer 205 may advantageously employ the priority and percentage to automatically choose the order of which access points through which the dialer 205 will attempt to establish communication to the communication network 120. According to one embodiment, the priority and percentage may advantageously not be visible to the user.

After selecting an access point, the connection process 1000 proceeds to BLOCK 1010, where the dialer 205 uses the connection information to configure the dialer 205 to the appropriate protocols, dials the selected access point, and attempts to establish communication with the hardware and software systems of the access point. In decision BLOCK 1015, the dialer 205 determines whether the connection attempt was successful. When the connection is successful, the connection process 1000 ends, when it is not, the connection process 1000 returns to BLOCK 1005 and selects another access point.

According to one embodiment, connection attempts may fail for a number of reasons. For example, the attempt may fail because the access point was busy, for example, it was occupied by another user, because the access point is inaccessible, because the access point is non-functional, or the like. When connection failure occurs, the dialer 205 selects an alternate access point. According to one embodiment, the alternate access point may be an access point with the same priority in the case of percentage use, another access point for a particular CSP, or another access point from another phone book. In this manner, the dialer 205 automatically proceeds through available access points based on, for example, priorities and percentages, until a connection is successfully made. According to one embodiment, the dialer 205 may return to an already tried access point after, for example, a certain priority threshold is reached, after exhausting all other access points at a particular priority or priority range, after exhausting all other access points for a particular CSP 140, group of CSPs, or the like. In one aspect, the connection process 1000 repeats until a connection is made or the user cancels the connection attempt.

Although the connection process 1000 is disclosed with reference to preferred and alternative embodiments, a skilled artisan will recognize from the disclosure herein other embodiment which highlight other aspects disclosed in the foregoing. For example, the connection process 1000 may include a registration process, banking functions, authentication services, exchange of digital credentials, or the like.

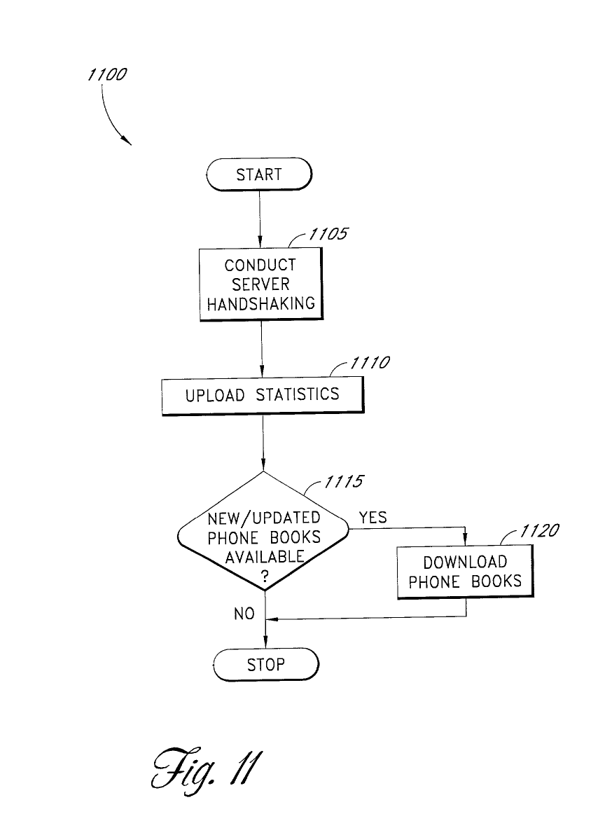

FIG. 11 illustrates a flow chart of a server notification process 1100 according to aspects of an embodiment of the invention. According to FIG. 11, the notification process 1100 begins at BLOCK 1105 when the dialer 205 conducts handshaking with the management server 135. According to one embodiment, the communication between the dialer 205 and the management server 135 occurs shortly after the dialer 205 makes a successful connection using the foregoing dialer connection process 1100. According to another embodiment, the communication may occur at set intervals, after a specific amount of online use, or the like. In addition, the dialer 205 or the management server 135 may initiate communication, for example, based on the need or availability of updated phone books, other connection information, connection statistics or the like.

According to another embodiment, the foregoing communication between the dialer 205 and the management server 135 may advantageously occur through the access to the communication network 120 from an access point of a particular CSP 140. Alternatively, the communication may occur as a direction connection from the 140 to the management server 135 or as a direct connection from the dialer 205, such as, for example, an 800 number.

After conducting handshaking, such as, for example, security authorization or authentication, trading of digital credentials, ensuring compatible protocols, or the like, the notification process 1100 proceeds to BLOCK 1110, where the dialer 205 uploads statistical data from the connection statistics database 215. In one aspect, the statistics gathered by the dialer 205 may include statistics detailing connection duration, quality, speed, location, or the like. Furthermore, the statistics may include information about the other computing devices 110 with which the user computing device 105 has or is exchanging information. For example, when the user is browsing online content present on the World Wide Web (WWW), the dialer 205 may store the addresses, names, uniform resource locator (URL) descriptors, or other information indicative of the websites and types of content being viewed by the user to be later uploaded to the management server 135.

At decision BLOCK 1115, the dialer 205 determines the availability of new or updated phone books. When modified or new phone books are available, the dialer 205, at BLOCK 1120, receives the updated phone books from, for example, the management server 135. Thereafter the notification process 1100 ends. Also, when the dialer 205 determines at decision BLOCK 1115 that modified or new phone books are available, the notification process 1100 ends.

According to one embodiment, the notification process 1100 is transparent to the user, including, for example, the installation of the phone books into the dialer database 210. According to this embodiment, the dialer 205 advantageously accesses the updated or modified phone book connection information the next time the dialer 205 access the dialer database 210.

According to another embodiment, the server notification process 1100 may advantageously be modified to include a review of whether updated or modified versions of the connectivity application 125 or other software resources used in the establishment of communication to the access provider 115 is desired. The transfer and installation of the foregoing updates, where possible, may also be transparent to the user.

Based on the foregoing, aspects of the invention provide the user with the dialer 205 that is highly automated and does not require significant skill or expertise to connect the communication network 120.

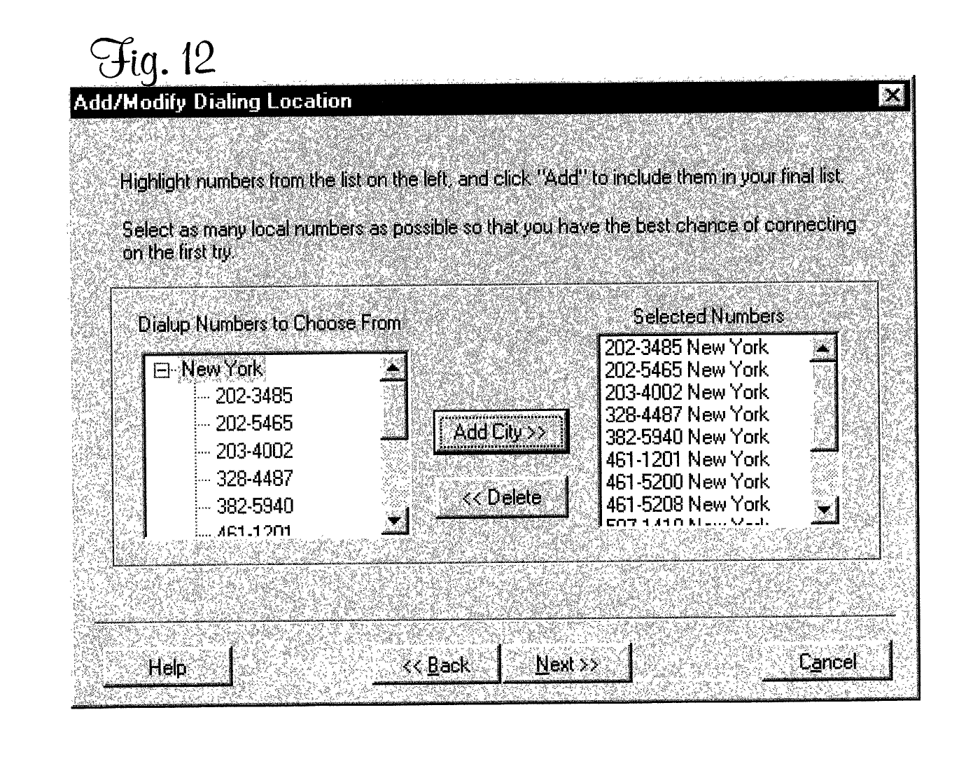

FIG. 12 illustrates an exemplary user interface screen, according to aspects of an embodiment of the invention. As shown in FIG. 12, one embodiment of the invention allows the user to choose which access points he or she desires to load into the dialer. Further according to the illustrated embodiment, the user does not see the priorities or percentages associated therewith. Therefore, after the user chooses which access points or CSPs the user is interested in using, the dialer 205 advantageously attempts to establish connections with those access points chosen by the user in the order of their respective priorities and percentages.

The aforementioned description illustrating the system and method for managing user connectivity to the communication network 120 of the present invention improves an access provider's ability to monitor and service its users through the use of an upgradeable and configurable connectivity applications 125. The highly automated task handling functionality of the connectivity application 125 reduces user interaction and insures that updates to the connectivity application 125 will be acquired and installed in a timely manner.

Additionally, the access provider 115 is better able to maintain software continuity among all users. This disclosed system also improves connectivity to the communication network 120 by providing methods to evenly distribute connection traffic across the access points hosted by the access provider 115. Furthermore, the system provides functionality to monitor the hosted access points, identify potential connection problems, and provide users with updates to the connection information, thereby avoiding the problems before they are encountered by the users. In another embodiment, the system can download new versions of the connectivity applications 125 thereby updating the connectivity applications 125 as needed.

Although the foregoing description of the invention has shown, described and pointed out novel features of the invention, it will be understood that various omissions, substitutions, and changes in the form of the detail of the system as illustrated as well as the uses thereof, may be made by those skilled in the art without departing from the spirit of the present invention. Consequently the scope of the invention should not be limited to the foregoing discussion but should be defined by the appended claims.

What is claimed is:

1. A system for establishing communication between a user computing device and a communication network, the system comprising:
a user computing device;
a connectivity application resident on the user computing device;
a communication network; and
an access provider comprising
one or more access points, wherein each access point includes connection information that may used by the connectivity application to establish communication between the user computing device and the communication network, and
a management server which assigns a priority value to the connection information associated with at least some of the one or more access points, wherein the connectivity application accesses the connection information corresponding to one of the one or more access points based on the priority value assigned thereto.

2. The system of claim 1, wherein the priority value associated with a particular access point includes a measurement of a cost of using of the particular access point.

3. The system of claim 2, wherein the measurement of the cost of using the particular access point includes measurements associated with one of a geographic measurement, time measurement, and day measurement.

4. The system of claim 1, wherein the priority value associated with a particular access point includes a measurement of a connection quality of the particular access point.

5. The system of claim 4, wherein the measurement of the connection quality includes measurements of one of busy signals and nonfunctional connection information.

6. The system of claim 1, wherein the priority value associated with a particular access point includes a measurement of an available capacity of the particular access point.

7. The system of claim 6, wherein the measurement of the available capacity includes measurements of one of discount pricing for the particular access point, volume commitments to the access point, and load balancing over the hardware and software systems associated with the access point.

8. The system of claim 1, wherein the priority value associated with a particular access point includes a measurement of combinations of a cost of use, a connection quality, and an available capacity.

9. The system of claim 8, wherein the combinations are weighted.

10. The system of claim 1, wherein the management server uses the priority value associated with a particular access point to route around the particular access point.

11. The system of claim 1, wherein the management server uses the priority value associated with a particular access point to provide a first type of service to a first type of user, and a second type of service to a second type of user.

12. The system of claim 1, wherein the management server assigns percentages to at least some of the access points.

13. The system of claim 12, wherein connectivity application uses the percentage to choose between two access points when the priority value of the two access points is the same.

14. The system of claim 1, wherein the access points are organized by one or more communication service providers and wherein the management server assigns a priority value to at least one of the communication service providers.

15. The system of claim 1, wherein the access points are organized by one or more communication service providers and wherein the management server assigns a percentage to at least one of the communication service providers.

16. The system of claim 1, wherein the connectivity application comprises a dialer.

17. The system of claim 1, wherein the management server updates the at least one of the priority values and connection information resident on the connectivity application.

18. A server communicating with one or more connectivity applications resident on one or more computing devices, wherein each connectivity application establishes communication between one of the computing devices and a communication network, the server comprising:
connection information corresponding to each of a plurality of communication service providers, wherein the connection information corresponding to one of the communication service providers may be used by a connectivity application resident on a computing device for connecting the computer device to a communications network through the one communication service provider;
a management module which assigns a priority value to the connection information corresponding to at least some of the communication service providers, wherein the priority value for a particular communication service provider relates to at least a cost of using the particular communication service provider; and
a communication module which transfers to at least one of the connectivity applications at least some of the connection information and their corresponding priority values.

19. The server of claim 18, wherein the cost includes measurements associated with one of a geographic measurement, time measurement, and day measurement.

20. The server of claim 18, wherein the management module assigns percentages to the connection information corresponding to at least two communication service providers, each percentage governing the probability the associated connection information will be used by a connectivity application.

21. A server communicating with one or more connectivity applications resident on one or more computing devices, wherein each connectivity application establishes communication between one of the computing devices and a communication network, the server comprising:
connection information corresponding to each of a plurality of communication service providers, wherein the connection information corresponding to one of the communication service providers may be used by a connectivity application resident on a computing device for connecting the computer device to a communications network through the one communication service provider;
a management module which assigns a priority value to the connection information corresponding to at least some of the communication service providers, wherein the priority value for a particular communication service provider relates to at least a measurement of a connection quality of the particular communication service provider; and
a communication module which transfers to at least one of the connectivity applications at least some of the connection information and their corresponding priority values.

22. The server of claim 21, wherein the measurement of the connection quality includes measurements of one of busy signals and nonfunctional connection information.

23. The server of claim 21, wherein the management module assigns percentages to the connection information corresponding to at least two communication service providers, each percentage governing the probability the associated connection information will be used by a connectivity application.

24. A server communicating with one or more connectivity applications resident on one or more computing devices, wherein each connectivity application establishes communication between one of the computing devices and a communication network, the server comprising:
connection information corresponding to each of a plurality of communication service providers, wherein the connection information corresponding to one of the communication service providers may be used by a connectivity application resident on a computing device for connecting the computer device to a communications network through the one communication service provider;
a management module which assigns a priority value to the connection information corresponding to at least some of the communication service providers, wherein the priority value for a particular communication service provider relates to at least a measurement of an available capacity of the particular communication service provider; and
a communication module which transfers to at least one of the connectivity applications at least some of the connection information and their corresponding priority values.

25. The server of claim 24, wherein the measurement of the available capacity includes measurements of one of discount pricing, volume commitments, and load balancing.

26. The server of claim 24, wherein the management module assigns percentages to the connection information corresponding to at least two communication service providers, each percentage governing the probability the associated connection information will be used by a connectivity application.

27. A server communicating with one or more connectivity applications resident on one or more computing devices, wherein each connectivity application establishes communication between one of the computing devices and a communication network, the server comprising:
connection information corresponding to each of a plurality of communication service providers, wherein the connection information corresponding to one of the communication service providers may be used by a connectivity application resident on a computing device for connecting the computer device to a communications network through the one communication service provider;
a management module which assigns a percentage to the connection information corresponding to at least some of the communication service providers, wherein the percentage at least in part governs the probability that a particular communication service provider will be used by the connectivity application; and
a communication module which transfers to at least one of the connectivity applications at least some of the connection information and their corresponding percentages.

28. The server of claim 27, wherein the management module assigns priority values to the connection information corresponding to at least some of the communication service providers, each priority value governing the order in which the associated connection information will be used by a connectivity application.

29. A server communicating with one or more connectivity applications resident on one or more computing devices, wherein each connectivity application establishes communication between one of the computing devices and a communication network, the server comprising:
connection information corresponding to each of a plurality of communication service providers, wherein the connection information corresponding to one of the communication service providers may be used by a connectivity application resident on a computing device for establishing communication between the computer device and a communications network through the one communication service provider;
a management module which assigns an order value to the connection information corresponding to at least some of the communication service providers; and
a communication module which transfers to at least one of the connectivity applications at least some of the connection information and their corresponding order values.

30. The server of claim 29, wherein the order value comprises a priority value and wherein the priority value comprises one of a cost of use, a connection quality, and an available capacity.

31. The server of claim 29, wherein the order value comprises a percentage and wherein the percentage governs a likelihood that some of the connection information will be used.

32. The server of claim 29, wherein the management module allows a system administrator to manually adjust the order value.

33. The server of claim 29, wherein the management module receives performance statistics from the connectivity application and uses the statistics to update the order values.

34. A method of controlling a connectivity application, the method comprising:
prioritizing connection information associated with a plurality of access points based on an order value for at least some of the access points; and
transferring the connection information to a connectivity application resident on a computing device.

35. The method of claim 34, wherein the order value corresponds at least to a cost of using the access point associated with the order value.

36. The method of claim 34, wherein the order value corresponds at least to an available capacity of the access point associated with the order value.

37. The method of claim 34, wherein the order value corresponds at least to a connection quality of the access point associated with the order value.

38. The method of claim 34, further comprising receiving performance statistics from the dialer, the performance statistics associated with the performance of the dialer during at least one established connection between the dialer and an access point.

39. The method of claim 38, further comprising changing the order value corresponding to at least one access point based on the received performance statistics.

40. The method of claim 34, further comprising changing the order value corresponding to at least one access point to route around access points experiencing communication interruption.

41. The method of claim 34, further comprising changing the order value corresponding to at least one access point based on the at least one access point dropping below a threshold value of one or more metrics.

42. The method of claim 41, wherein the one or more metrics comprise a connection quality measurement.

43. The method of claim 34, further comprising automatically changing the order value corresponding to at least one access point based on a review metrics on which the order value is based.

44. A method of managing connectivity from a computing device to a computer network, the method comprising:
processing connection information in a prioritized order, wherein the connection information is associated with a plurality of access points to a communication network; and
using the connection information in priority order to direct a computing device to establish a connection with the communication network through one of the plurality of access points.

45. The method of claim 44, further comprising gathering statistical data pertaining to a plurality of performance metrics.

46. The method of claim 44, further comprising receiving updated connection information.

47. The method of claim 44, further comprising receiving an updated priority order.

48. A connectivity application for establishing communication between a computing device and a communication network, the connectivity application comprising:
prioritized connection information corresponding to each of a plurality of access points; and corresponding to connection information associated with a higher priority than another access point.

49. A connectivity application for establishing communication between a computing device and a communication network, the connectivity application comprising:
a connectivity database storing prioritized connection information associated with a plurality of access points; and
a connectivity application which directs a computing device to attempt to communicate with a computer network through one of the plurality of access points associated with connection information corresponding to a higher priority.

50. The connectivity application of claim 49, wherein the dialer automatically directs the computing device to attempt to communicate with a computer network through a second one of the plurality of access points when the original attempt fails.

51. The connectivity application of claim 50, wherein the second one of the plurality of access points corresponds to connection information having the next highest priority.

52. The connectivity application of claim 49, wherein the one access point is also associated with connection information corresponding to a percentage.

53. An internet service provider, comprising one or more access points providing access to a communication network for one or more computing devices, wherein the internet service provider directs at least one of the computing devices to attempt to establish communication through one of the access points having a highest priority value associated therewith.

54. A method of providing communication links to a computer network for multiple users through hardware and software systems controlled by a plurality of business entities, the method comprising:
agreeing with at least two service providers to allow users to access a computer network from computing devices through a plurality of access points associated with each of the service providers;
receiving connection data from the service providers for the plurality of access points;
ordering the connection data into a preferred order;
transferring the preferred order to at least one of the computing devices.
